(19) United States
(12) Patent Application Publication
(10) Pub. No.: US 2003/0112992 A1
(43) Pub. Date: Jun. 19, 2003

(54) Self-retaining element for a behind-the-ear communication device

(76) Inventor: Gary M. Rapps, Sunrise, FL (US)

Correspondence Address: MOTOROLA, INC., 1303 EAST ALGONQUIN ROAD, IL01/3RD, SCHAUMBURG, IL, 60196

(21) Appl. No.: 10/017,957

(22) Filed: Dec. 14, 2001

(51) Int. Cl. H04R 25/00

(52) U.S. Cl. 381/381; 381/327; 381/330; 381/370

(57) ABSTRACT

A communication device (300) for use behind an ear (200) comprises a housing (302), a sound delivery tube (310), and a self-retaining element (316). The sound delivery tube (310) is coupled to the housing. The self-retaining element (316) is coupled to the housing (302) or the sound delivery tube (310). The self-retaining element (316) rests beneath an inferior crus (216) of the ear (200) and provides positive retention of the communication device (300) to the ear (200) when the sound delivery tube (310) is positioned for sound delivery to the ear (200).

### CROSS-REFERENCE TO RELATED APPLICATION

The present application is related to U.S. Pat. No. 6,009,183, filed Jun. 30, 1998 by Taenzer et al., titled “Ambidextrous Sound Delivery Tube System,” the disclosure of which prior application is hereby incorporated by reference, verbatim and with the same effect as though it were fully and completely set forth herein.

The present application is also related to U.S. Pat. No. 6,101,259, filed Aug. 3, 1998 by Rapps, titled “Behind the Ear Communication Device” the disclosure of which prior application is hereby incorporated by reference, verbatim and with the same effect as though it were fully and completely set forth herein.

### FIELD OF THE INVENTION

The present invention relates generally to a self-retaining element for a behind-the-ear communication device.

### BACKGROUND OF THE INVENTION

Behind-the-ear (“BTE”) communication devices can be found in many forms. One popular construction is to have a hook shaped element having a main portion that houses device electronics, and a sharply curved portion that hooks around the helix of the ear to provide a conduit for sound to the ear canal.

Established applications for a BTE communication device are its use as a direct replacement for a r microphone/receiver for any combination of use with a portable radio, cordless telephone and/or cellular telephone. The degree of which the BTE communication device stays on the ear can be very important. For some groups, for example the public safety markets, it can be critical, particularly for the physically active user.

Current models of the BTE communication devices are limited in the ways they are retained on the ear. The main element of retention is provided by the combination of the “hook around the top of the ear” with the spring-coiled cable that is clipped to the user's collar as illustrated in FIG. 1. This hooked tension line works well, but is applicable only to a device with an integral cable. For a wireless device, however, the only means of ear retention is the compression/frictional fit between the BTE housing and the surrounding ear surfaces. This mode of retention is often compromised by the user's eyeglass temple piece, and the surface contact provided by the shape of the sulcus (groove behind the ear), pinna (outer ear flap), and/or the curvature of the head behind the ear, and is further compromised in the presence of skin perspiration.

There are two lesser methods of retention that were introduced with the wired device, but they met with very limited acceptance: the adhesive pad that bonds the BTE communication device to the sulcus, and the elastomeric ear strap that loops under the ear lobe like a rubber band.

Thus, there exists a need for a self-retaining element for behind-the-ear communication devices, for both wired and wireless behind-the-ear communication devices for the physically active user.

### BRIEF DESCRIPTION OF THE FIGURES

A preferred embodiment of the invention is now described, by way of example only, with reference to the accompanying figures in which:

FIG. 1 (prior art) illustrates a behind-the -ear communication device retained on an ear by a combination of a “hook around the top of the ear” with a spring coiled cable clipped to a user;

FIG. 2 illustrates a posterior view and a lateral view of an outer ear;

FIG. 3 illustrates a side view of a behind-the-ear communication device in accordance with the preferred embodiment of the present invention;

FIG. 4 illustrates the behind-the ear communication device of FIG. 3 inserted into the ear of FIG. 2 in accordance with the preferred embodiment of the present invention;

FIG. 5 illustrates a preferred and an alternative shape of a self-retaining element incorporated in the behind-tie-ear communication device of FIG. 3 in accordance with the present invention; and

FIG. 6 illustrates the preferred geometry of the self-retaining element of FIG. 5 in accordance with the present invention.

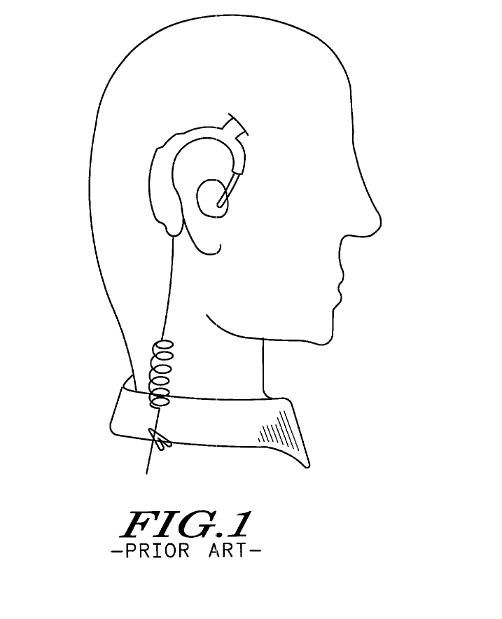

### DETAILED DESCRIPTION OF THE PREFERRED EMBODIMENT

While the specification concludes with claims defining the features of the present invention that are regarded as novel, it is believed that the present invention will be better understood from a consideration of the following description in conjunction with the corresponding figures, in which like reference numerals are carried forward.

The present invention provides for a behind-the-ear (“BTE”) communication device having a form factor that delivers a comfortable fit across a wide variety of users. The form factor stems from a discovery, through anatomical experiments, of a common ear contact surface configuration, formed using tangential arcs, that provides universal comfort and fit for ears of different shapes and sizes, across a major portion of the population. In particular, the present invention provides an element of retention of a wireless BTE communication device on a user's ear based on the relationship between that element and the structural anthropometric details of the human ear.

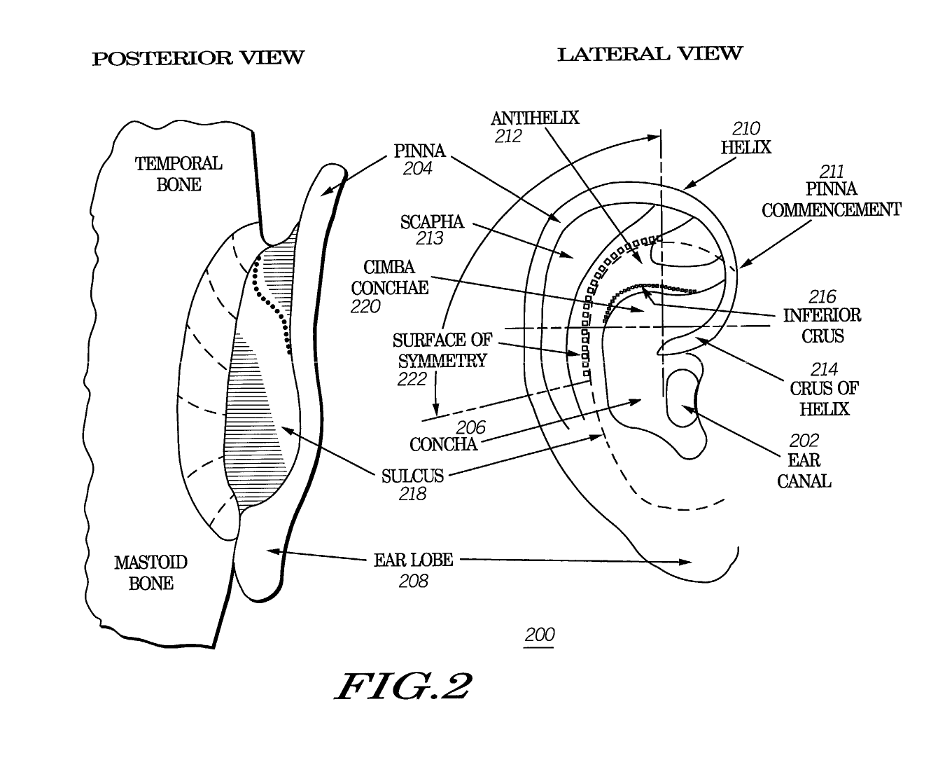

A posterior view and lateral view of an outer ear 200 is shown in FIG. 2 for the purpose of establishing reference elements. The ear 200 has a canal (“ear canal”) 202 that extends inward, forward, and slightly upward to an eardrum (not shown), and a pirma 204, which is a cartilaginous appendage, which projects in an outward manner. The pinna 204 has a cavity, along a front section of the ear, referred to as a concha 206, which forms a conduit for sound to the ear canal 202. The pinna 204 comprises a lobe 208 situated below the ear canal 202, and an outer rim, the helix 210, joined to the lobe 208 and forming an inwardly curving rim that forms the periphery of the scapha 213_{[ath0221]}. The antihelix 212 is an elevated “Y” shaped ridge between the concha 206 and the scapha 213 that forms the periphery of the concha 206. The helix 210 extends from the earlobe 208 upwardly to a crest, i.e., the top portion of the outer ear 200 that continues around and curves downwardly to an attachment point on the head. The rim of the helix extends and curves further downward, forming a ridge that vanishes into the central floor of the concha 206, called the crus of the helix 214. The edge between the antihelix 212 and the upper half of the concha 206 forms a recessed furrow called the inferior crus 216. The groove or portion of the ear behind the helix 210 on the backside of the pinna 204 that attaches the ear 200 to the remainder of the head is referred to as the sulcus 218.

As shown in FIG. 3, the BTE communication device 300 comprises a hooked shaped housing having a form factor to fit around the typical human ear 200. The housing 302 houses electronic circuitry (not shown) 304, 306 that receives and processes audio signals. The housing 302 has a concave “inner” surface that fits behind and around a user's outer ear 200, i.e., the inner surface is that part of the exterior surface of the housing that abuts or makes contact with the sulcus 218 of the ear.

The housing 302 has a terminal end 308 that functions as a receptacle or tube mount for an attached sound delivery tube 310. The sound delivery tube 310 is pivotable about the terminal end 308 of the tubular portion to accommodate angular corrections to match a user's ear canal axis.

In the preferred embodiment of the present invention, the BTE communication device 300 has one sound delivery tube 310 intended to fit all users. Because of the design, the sound delivery tube 310 is compliant to fit a broad range of ears. As illustrated in FIG. 3, the sound delivery tube 310 is substantially L-shaped with a preferred angular orientation of approximately eighty degrees to anatomically match the entrance angle of the ear canal 202.

The eartip 312 illustrated in the figures is a flower-shaped eartip formed of a resilient material that includes threc-flower petals 314 extending from a base in the preferred embodiment. A sound output opening (not shown) is provided at the center of the flower-shaped eartip 312 for delivering sound to the ear canal 202. The eartip 312 retains the end of the sound delivery tube 310 in position within the user's ear canal 202 by engaging the walls of the ear canal 202 with uniform pressure with the resilient petals of the flower 314. Thus, the eartip 312 assists in maintaining concentricity of at least a portion of the sound delivery tube 310 with respect to the ear canal 202 (preferably the center line of the ear canal) for the purposes of comfort for long term use, and to provide sound that can be acoustically coupled with the ear canal 202 in a non-occluded fashion (i.e., non-blocking the ambient sound).

The flower-shaped eartip 312 is only one example of an eartip that may be used with the present invention. Many other eartip shapes may also be used, including, but not limited to, bud-shaped eartips, guppy-shaped eartips, and the like. Other shapes and constructions of custom earmold eartips and stock eartips may also be connected to the sound delivery tube 310 according to the present invention.

The sound delivery tube 310 is also preferably formed of a resilient material (e.g., a soft rubbery material) that flexes to accommodate differences in ear dimensions and angles. Preferably, the sound delivery tube 310 has sufficient resiliency to return to its original shape when not subject to external forces. The flexibility of the material used for the sound delivery tube 310 allows one size tube to fit substantially all ear shapes and sizes. Alternatively, the sound delivery tube 310 may be formed of a more rigid material. A rigid sound delivery tube 310 may be provided in different sizes. Thus, the sound delivery tube 310 may be formed of any suitable material, such as, plastic, silicone rubber, or the like.

In order to retain any BTE communication device 300 on the ear 200, certain physical constraints must be -met. These constraints center around how well the shape of the device matches the ear (i.e., fit), and how well the BTE communication device 300 grips the ear (i.e., retention). These constraints combine to define user comfort.

As further illustrated in FIG. 3, the present invention incorporates a self-retaining element 316 that is preferably molded onto the sound delivery tube 310 or the housing 302 itself that embodies anatomical features of the human ear 200 to provide coupling to the ear 200.

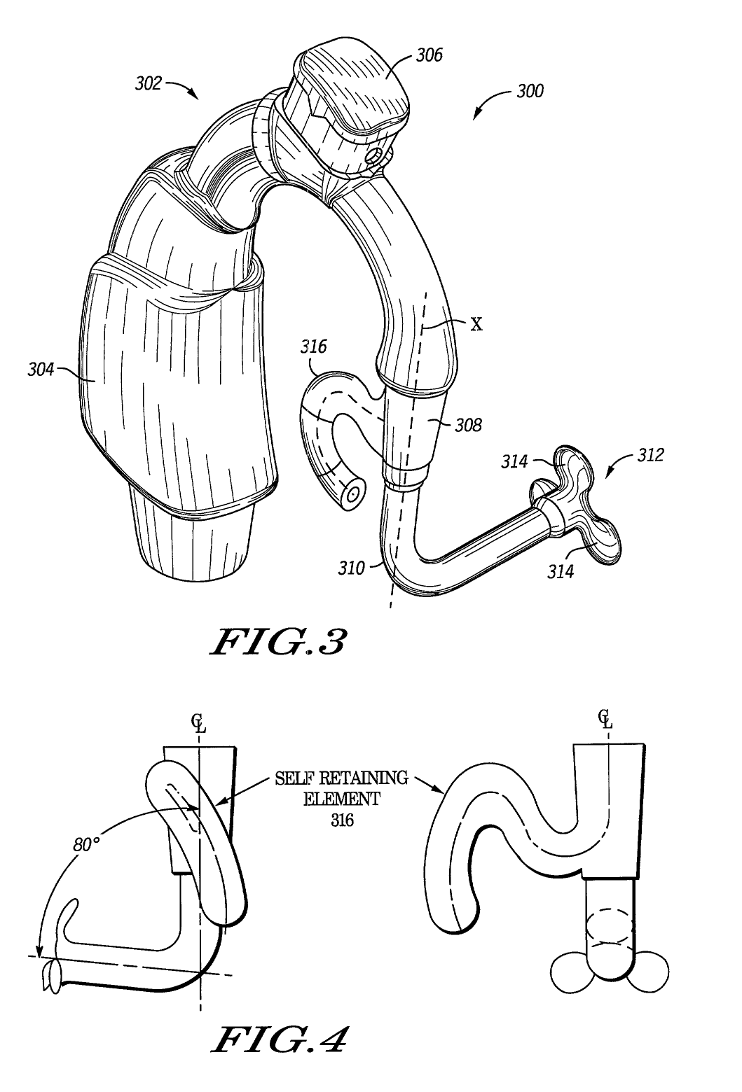

An exploded view of the self-retaining element 316 is illustrated in FIG. 4, and its application on the ear 200 is illustrated in FIG. 5. Due to the nature of the shape of the self-retaining element 316, it is angled inward to occupy the space under the ear fold called the inferior crus 216. Because of this orientation, the preferred embodiment shown represents the shape required to provide secure retention on the user's right ear. A mirror image part would then provide the same level of retention on the user's left ear.

The self-retaining element 316 contains compound curves in two planes that contribute to the way the fit and the coupling is achieved. When attached to the ear 200, the self-retaining element 316 causes a gentle pinch (i.e., squeeze) 500 across the pinna 204 between the outer (i.e., sulcus) 218 and inner (i.e., concha) 206 portions of the ear 200. The anatomically curved element 316 contacts the skin inside a fold in the concha bowl (i.e., cimba conchae) 220 just under the inferior crus 216. Due to the nature of the shape of the self-retaining element 316, it fits into the ear in a way that it provides positive retention with the ear's anatomy in the X-axis, the Y-axis, and the Z-axis, further enhancing retention. The area of contact is directly opposite the “surface of symmetry” 222 on the sulcus 218. There is a nominal space between the BTE communication device 300 and the self-retaining element 316 to allow for the natural thickness of the ear 200. The BTE communication device 300 is fully supported by its contact on the sulcus 218, and is “locked” onto the ear 200 by a gentle spring contact provided by the self-retaining element 400 as illustrated in FIGS. 4, 5 and 6. The thickness of this section between the sulcus 218 and the cimba conchae 220 happens to be another area in which there is very little anthropometric deviation across a wide range of ear sizes.

An anatomical ear thickness measurement study was performed on fiftyeight participants, including men and women ranging from 88 to 296 pounds. The average thickness measured between the sulcus 218 and the cimba conchae 220 under the inferior crus 216 was 0.118 inches, with a deviation of +0.027 and 0.020 inches. This range is easily accommodated because of the flexible properties of the self-retaining element 316. Referring back to FIG. 4, the “S” shape self-retaining element 316 is designed specifically to conform to the range of thickness. The shape of the self-retaining element 316 consists of a broad spring contacting area designed to minimize the force in any one area, increasing user comfort.

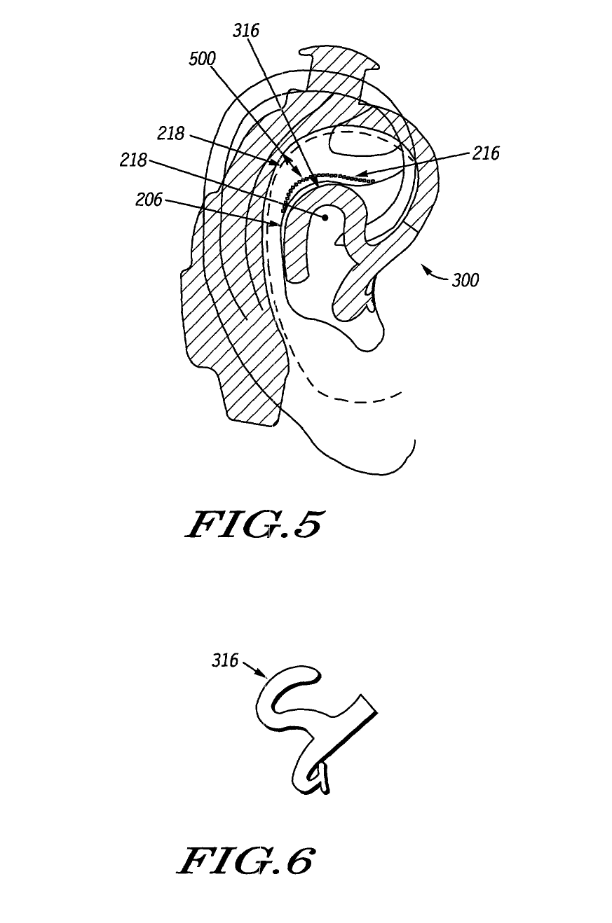

An alternate design of a “J” shape self-retaining element 316 as illustrated in FIG. 6 also produces the same desired effects. The self-retaining element is also preferably formed from a resilient material (e.g., a soft rubbery material) that flexes to accommodate different ear thickness. An alternate design could include a metal spring wire, or the like, to add resilience or force to the spring properties of the self-retaining element 316. Preferably, the self-retaining element 316 has sufficient resiliency to return to its original shape when not subject to external forces. Those skilled in the art will readily recognize that the self-retaining element 316 can vary in shape and size and still remain within the scope of the present invention.

As clearly illustrated in FIG. 3, this self-retaining element 316 is preferably molded onto the sound delivery tube 310. This orientation provides an additional aid with the installation of the BTE communication device 300 on the user's ear. As the sound delivery tube 310 is oriented toward the ear, so is the self-retaining element 316 aligned with the cimba conchae 220. This permits easy installation, while providing a comfortable fit on the user's ear.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

I claim:

1. A communication device for use behind an ear, comprising:
a housing;
a sound delivery tube coupled to the housing; and
a self-retaining element, coupled to at least one of the housing and the sound delivery tube,
wherein the self-retaining element rests beneath an inferior crus of the ear and provides positive retention of the communication device to the ear when the sound delivery tube is positioned for sound delivery to the ear.

2. The communication device of claim 1 wherein the self-retaining element comprises compound curves in two planes.

3. The communication device of claim 2 wherein the compound curves of the self-retaining element fits anatomically into an inferior crus fold in a concha bowl.

4. The communication device of claim 1 wherein the self-retaining element contacts skin inside a fold in a concha bowl beneath the inferior crus of the ear.

5. The communication device of claim 1 wherein the self-retaining element provides positive retention to the ear on an x-axis, a y-axis and a z-axis.

6. The communication device of claim 1 wherein the self-retaining element comprises spring properties.

7. The communication device of claim 1 wherein the self-retaining element is positioned approximately ninety degree with respect to the sound delivery tube.

8. The communication device of claim 1 wherein the self-retaining element is molded onto the sound delivery tube.

9. The communication device of claim 1 wherein the self-retaining element comprises one of the following: an “S” shape spring curve, and a “J” shape spring curve.

10. The communication device of claim 1 wherein the self-retaining element is flexible.

11. The communication device of claim 1 wherein the self-retaining element is semi-rigid.

12. The communication device of claim 1 wherein the self-retaining element is constructed from a material selected from a group consisting of: rubber, plastic, and metal.

13. The communication device of claim 1 wherein the ear comprises a pinna, a sulcus, and a concha, and wherein the self-retaining element, when positioned on the ear, applies positive retention across the pinna of the ear between the sulcus and the concha.

14. The communication device of claim 1 wherein the communication device is wireless.

15. The communication device of claim 1 wherein the communication device is wired.

16. The communication device of claim 1 wherein the housing has a first section that rests on a sulcus of the ear, and wherein the positive retention of the communication device to the ear results from a space between the first section of the housing and the self-retaining element.

17. The communication device of claim 16 wherein a dimension across the space between the first section of the housing and the self-retaining element is 0.118 inches+/−0.054.

18. The communication device of claim 16 wherein the space between the first section of the housing and the self-retaining element becomes gradually smaller as the self-retaining element extends further away from the sound delivery tube.
